(19) United States
(12) Patent Application Publication
(10) Pub. No.: US 2024/0417231 A1
(43) Pub. Date: Dec. 19, 2024

(54) AERIAL WORK PLATFORM

(71) Applicant: Oshkosh Corporation, Oshkosh, WI (US)

(72) Inventor: Zeno Poltronieri, Oshkosh, WI (US)

(73) Assignee: Oshkosh Corporation, Oshkosh, WI (US)

(21) Appl. No.: 18/815,097

(22) Filed: Aug. 26, 2024

Related U.S. Application Data
(63) Continuation of application No. 18/424,462, filed on Jan. 26, 2024.
Application No. 18/424,462 is a continuation of application No. 16/384,594, filed on Apr. 15, 2019, now abandoned.

(30) Foreign Application Priority Data
Apr. 16, 2018 (IT) 102018000004537

(51) Int. Cl. B66F 11/04; B66F 13/00

(52) U.S. Cl. CPC B66F 11/046; B66F 13/00

(57) ABSTRACT

An aerial work platform includes a tractive assembly coupled to a chassis, a stabilizer arm movable between a rest position and an operating position, a cage defining a supporting surface, and a lifting assembly movable between a raised position and a fully lowered position. The lifting assembly includes a first lift arm extending along a first axis from a first proximal end portion to a first distal end portion and a second lift arm extending along a second axis from a second proximal end portion to a second distal end portion. The first proximal end portion is coupled to the chassis. The second proximal end portion is coupled to the first distal end portion. The second distal end portion is coupled to the cage. The first distal end portion and the second distal end portion extend in opposite directions when the lifting assembly is in the fully lowered position.

### CROSS-REFERENCE TO RELATED APPLICATIONS

This patent application is a continuation of U.S. application Ser. No. 18/424,462, filed on Jan. 26, 2024, which is a continuation of U.S. application Ser. No. 16/384,594, filed on Apr. 15, 2019, which claims the benefit of and priority to Italian Patent Application No. 102018000004537, filed on Apr. 16, 2018, the entire disclosures of which are incorporated by reference herein.

### TECHNICAL FIELD

The present invention relates to an aerial work platform.

In particular, the present invention relates to an aerial work platform of the type comprising a people-holding cage; and a support and transport assembly for the cage.

### BACKGROUND ART

Generally, the support and transport assembly for the cage comprises a self-propelled vehicle; a rotating turret coupled to the self-propelled vehicle for rotating, with respect to the self-propelled vehicle, around a substantially vertical axis of rotation; a lifting unit interposed between the turret and the cage to move the cage between a lowered rest position and a plurality of raised operating positions; and a stabilizer device to stabilize the aerial work platform in use.

The lifting unit comprises a telescopic arm comprising, in turn, a first section bar; a second section bar fitted inside the first section bar to move between a retracted position and an extracted position; a third section bar fitted inside the second section bar to move between a retracted position and an extracted position; and a fourth section bar fitted inside the third section bar to move between a retracted position and an extracted position.

The telescopic arm further comprises an operating device to move the aforementioned second, third, and fourth section bars between the respective extracted positions and the respective retracted positions.

The operating device comprises an actuator cylinder fitted inside the telescopic arm and interposed between the first section bar and the second section bar to move the second section bar between its extracted and retracted positions; a first rope-operated system fitted inside the telescopic arm to move the third section bar between its extracted and retracted positions; and a second rope-operated system fitted inside the telescopic arm to move the fourth section bar between its extracted and retracted positions.

The first rope-operated system usually comprises a first pair of ropes, which are coupled to the first section bar and the third section bar, and are wound around at least one first pulley coupled in an axially fixed manner to a first end of the second section bar; and a second pair of ropes, which are coupled to the first section bar and the third section bar, and are wound around at least one second pulley coupled in an axially fixed manner to a second end of the second section bar opposite the first end of the second section bar.

The second rope-operated system usually comprises a first pair of ropes, which are coupled to the second section bar and the fourth section bar, and are wound around at least one first pulley coupled in an axially fixed manner to a first end of the third section bar; and a second pair of ropes, which are coupled to the second section bar and the fourth section bar, and are wound around at least one second pulley coupled in an axially fixed manner to a second end of the third section bar opposite the first end of the third section bar.

The lifting unit further comprises at least one pipe (usually a plurality of pipes) to feed an operating fluid along the telescopic arm.

Each pipe comprises a first flexible segment fitted inside a first cable-holding chain, which extends outside the telescopic arm and is fixed to the first section bar and the third section bar; and a second flexible segment fitted inside a second cable-holding chain, which extends outside the telescopic arm and is fixed to the third section bar and the fourth section bar.

Since, usually, the four section bars must have relatively small cross-sections to meet regulatory and/or functional restrictions, the known aerial work platforms of the type described above have some drawbacks mainly due to the fact that the flexible segments of the pipes and the respective cable-holding chains must be mounted outside the telescopic arm and are therefore exposed to the risk of impacts and damage.

### DISCLOSURE OF INVENTION

The object of the present invention is to provide an aerial work platform, which is free of the drawbacks described above and simple and economical to implement.

According to the present invention, an aerial work platform is provided as claimed in the appended claims.

### BRIEF DESCRIPTION OF THE DRAWINGS

The present invention will now be described with reference to the accompanying drawings, which illustrate a non-limiting embodiment thereof, in which:

FIG. 1 is a schematic side view, with parts removed for clarity, of a preferred embodiment of the aerial work platform of the present invention;

FIG. 2 is a perspective view of a detail of the aerial work platform in FIG. 1;

FIG. 3 is a schematic perspective view, with parts in section and parts removed for clarity, of a first detail of FIG. 2;

FIG. 4 is a schematic perspective view, with parts in section and parts removed for clarity, of a second detail of FIG. 2;

FIG. 5 is a schematic perspective view, with parts in section and parts removed for clarity, of a third detail of FIG. 2;

FIG. 6 is a schematic perspective view, with parts in section and parts removed for clarity, of a fourth detail of FIG. 2;

FIG. 7 is a schematic perspective view, with parts in section and parts removed for clarity, of a fifth detail of FIG. 2;

FIG. 8 is a schematic perspective view, with parts in section and parts removed for clarity, of a sixth detail of FIG. 2; and

FIG. 9 is a schematic perspective view, in enlarged scale, of a detail of FIG. 8.

### BEST MODE FOR CARRYING OUT THE INVENTION

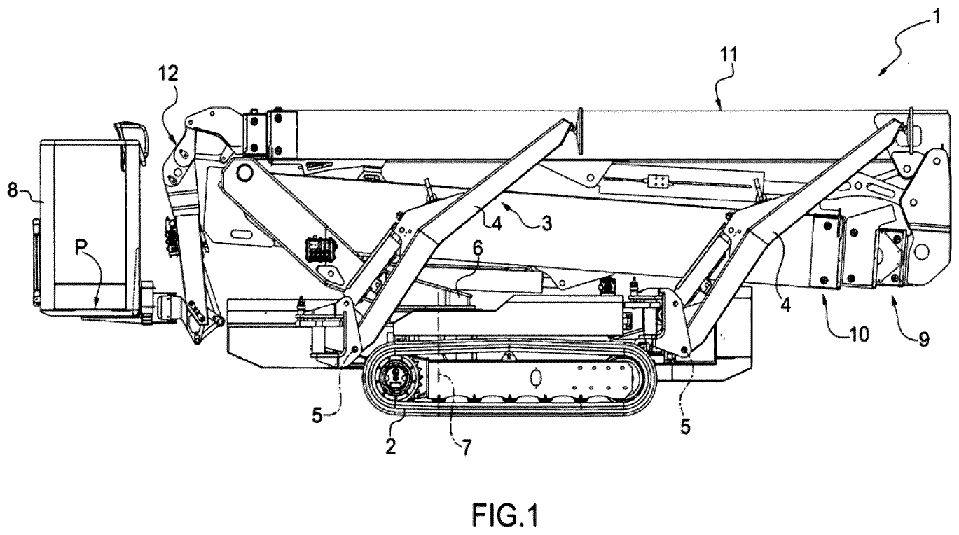

With reference to FIG. 1, reference numeral 1 indicates, as a whole, an aerial work platform comprising a tracked vehicle 2 provided with a stabilizer device 3 of a known type suitable to stabilize the aerial work platform 1 in use.

The device 3 comprises a plurality of oscillating arms 4 (in this case four arms 4), each of which is rotatably coupled to the vehicle 2 so as to oscillate, with respect to the vehicle 2, around a respective substantially horizontal fulcrum axis 5 between a rest position (FIG. 1) and an operating position (not shown).

The vehicle 2 further supports a rotating turret 6, which extends upwards from the vehicle 2 and is rotatably coupled to the vehicle 2 so as to rotate, with respect to the vehicle 2 and under the thrust of an operating device, of a known type and not shown, around a substantially vertical axis of rotation 7.

The aerial work platform 1 further comprises a people-holding cage 8 of a known type, which has a substantially horizontal supporting surface P and is connected to the turret 6 by the interposition of a lifting unit 9 configured to move the cage 8 between a lowered rest position (FIG. 1) and a plurality of raised operating positions (not shown).

The unit 9 comprises a plurality of lifting arms (in this case three lifting arms 10, 11, 12) arranged in succession and connected together in a known manner.

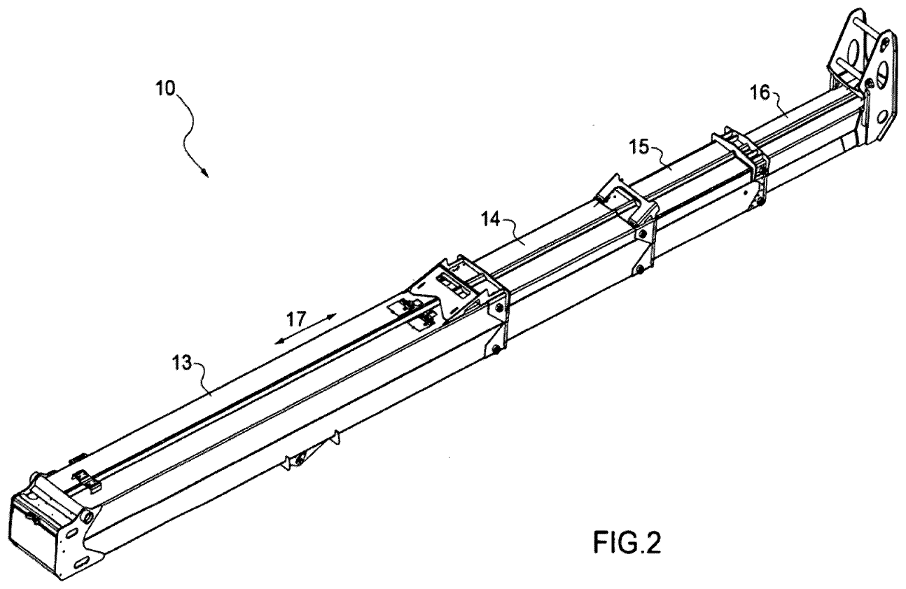

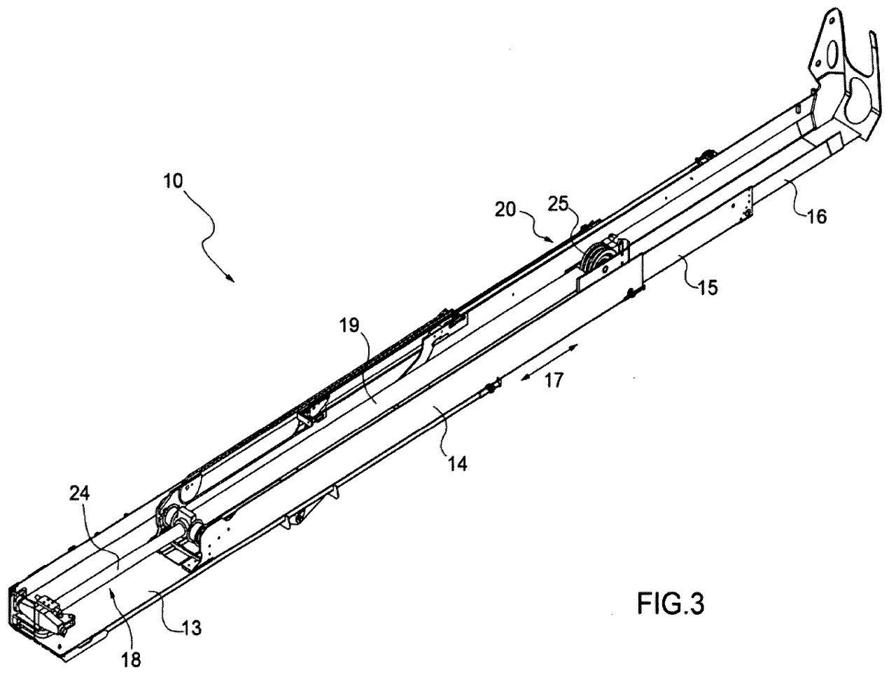

As shown in FIG. 2, the arm 10 is a telescopic arm comprising an axially fixed section bar 13 connected to the turret 6, and three movable section bars 14, 15, 16, of which the section bar 14 is fitted inside the section bar 13 and slidably coupled thereto, the section bar 15 is fitted inside the section bar 14 and slidably coupled thereto, and the section bar 16 is connected to the arm 11 and fitted inside the section bar 15 and slidably coupled thereto.

The section bars 14, 15, 16 have a parallelepiped shape with a substantially rectangular section and are movable between a retracted position (FIG. 1), in which the arm 10 has its minimum length, and an extracted position (not shown), in which the arm 10 has its maximum length.

With reference to Figures from 3 to 6, the section bars 14, 15, 16 are moved between the aforesaid retracted and extracted positions in a substantially rectilinear direction of movement 17 by an operating device 18 comprising an actuator cylinder 19, to move the section bar 14 between its retracted and extracted positions, a pair of rope-operated systems 20, 21, to move the section bar 15 between its extracted and retracted positions, and a pair of rope-operated systems 22, 23, to move the section bar 16 between its extracted and retracted positions.

The cylinder 19 extends inside the arm 10, is fixed to the section bar 14 parallel to direction 17, and has an output rod 24 fastened to the section bar 13.

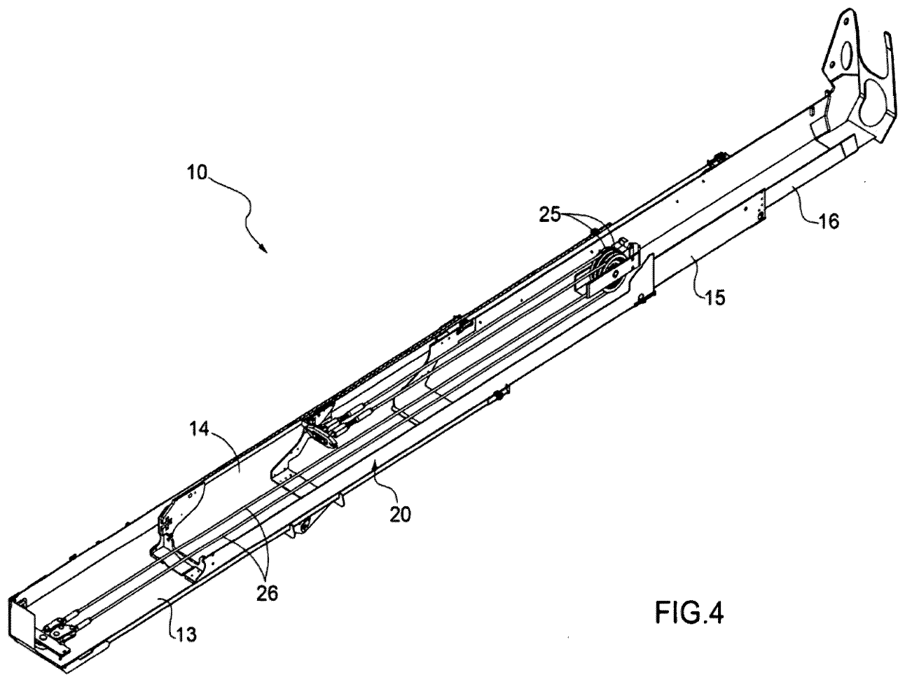

As shown in FIG. 4, the system 20 is fitted inside the arm 10, and in this case comprises a pair of pulleys 25 rotatably mounted at one free end of the cylinder 19, hence of the section bar 14, to move integrally with the section bar 14 in direction 17.

The system 20 further comprises a pair of ropes 26, each of which is wound around a respective pulley 25 and has two free ends, one fixed to the section bar 13 and the other one to the section bar 15.

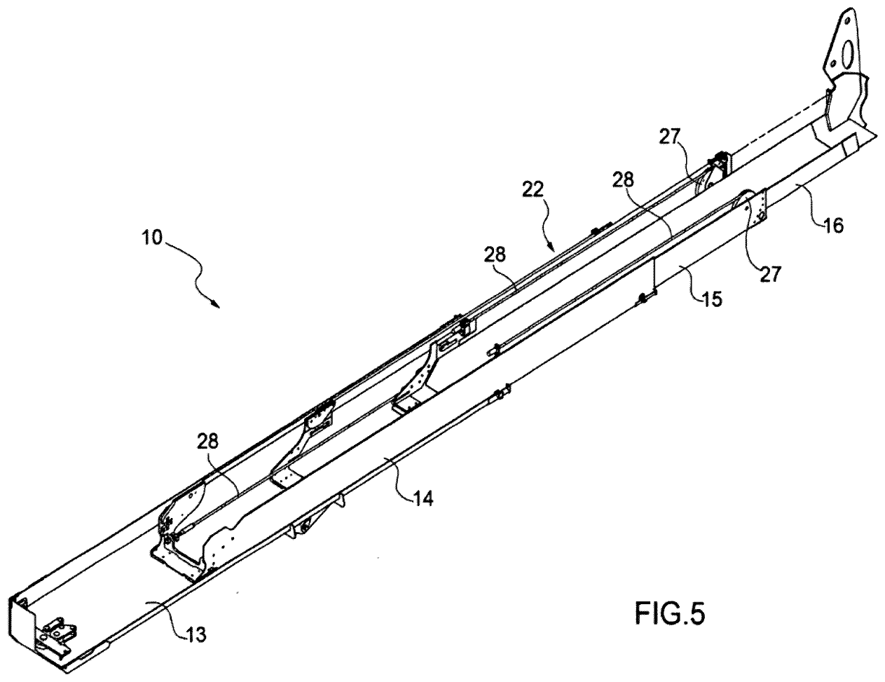

With reference to FIG. 5, the system 22 is fitted inside the arm 10, and in this case comprises a pair of pulleys 27 rotatably mounted at one free end of the section bar 15, to move integrally with the section bar 15 in direction 17.

The system 22 further comprises a pair of ropes 28, each of which is wound around a respective pulley 27 and has two free ends, one fixed to the section bar 14 and the other one to the section bar 16.

In use, the actuation of the cylinder 19 to move the section bar 14 from its retracted position to its extracted position involves both the movement of the pulleys 25 in direction 17, therefore the dragging of the section bar 15 by the ropes 26, and the movement of the pulleys 27 in direction 17, therefore the dragging of the section bar 16 by the ropes 28.

In other words, the actuation of the cylinder 19 to move the section bar 14 from its retracted position to its extracted position allows the two rope-operated systems 20, 22 to directly move the section bars 15 and 16 from their retracted positions to their extracted positions.

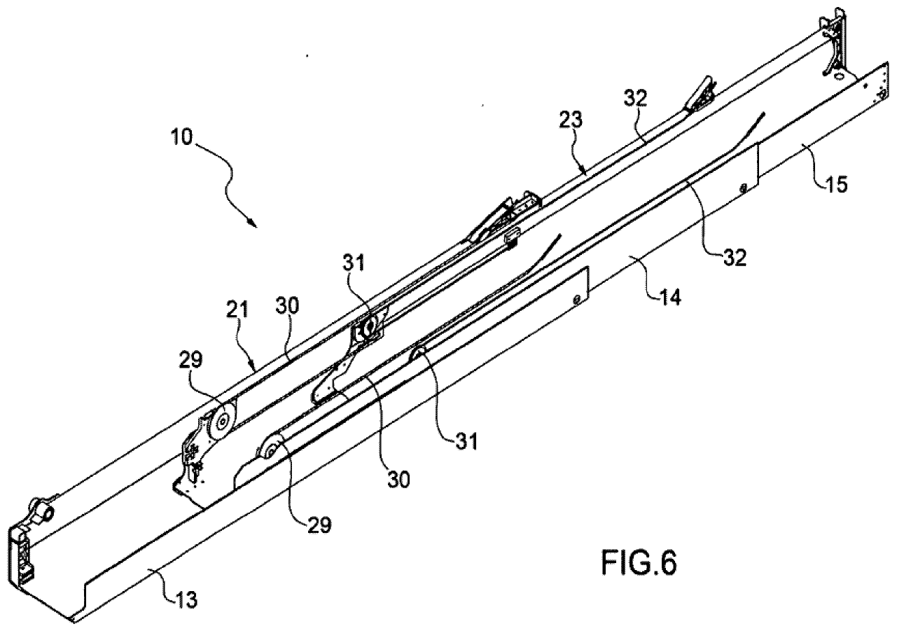

As shown in FIG. 6, the system 21 is fitted inside the arm 10, and in this case comprises a pair of pulleys 29, which are rotatably mounted at one free end of the section bar 14 opposite the free end of the section bar 14 on which the pulleys 25 are mounted, and are movable integrally with the section bar 14 in direction 17.

The system 21 further comprises a pair of ropes 30, each of which is wound around a respective pulley 29 and has two free ends, one fixed to the section bar 13 and the other one to the section bar 15.

The system 23 is fitted inside the arm 10, and in this case comprises a pair of pulleys 31, which are rotatably mounted at one free end of the section bar 15 opposite the free end of the section bar 15 on which the pulleys 27 are mounted, and are movable integrally with the section bar 15 in direction 17.

The system 23 further comprises a pair of ropes 32, each of which is wound around a respective pulley 31 and has two free ends, one fixed to the section bar 14 and the other one to the section bar 16.

In use, the actuation of the cylinder 19 to move the section bar 14 from its extracted position to its retracted position involves both the movement of the pulleys 29 in direction 17, therefore the dragging of the section bar 15 by the ropes 30, and the movement of the pulleys 31 in direction 17, therefore the dragging of the section bar 16 by the ropes 32.

In other words, the actuation of the cylinder 19 to move the section bar 14 from its extracted position to its retracted position allows the two rope-operated systems 21, 23 to directly move the section bars 15 and 16 from their extracted positions to their retracted positions.

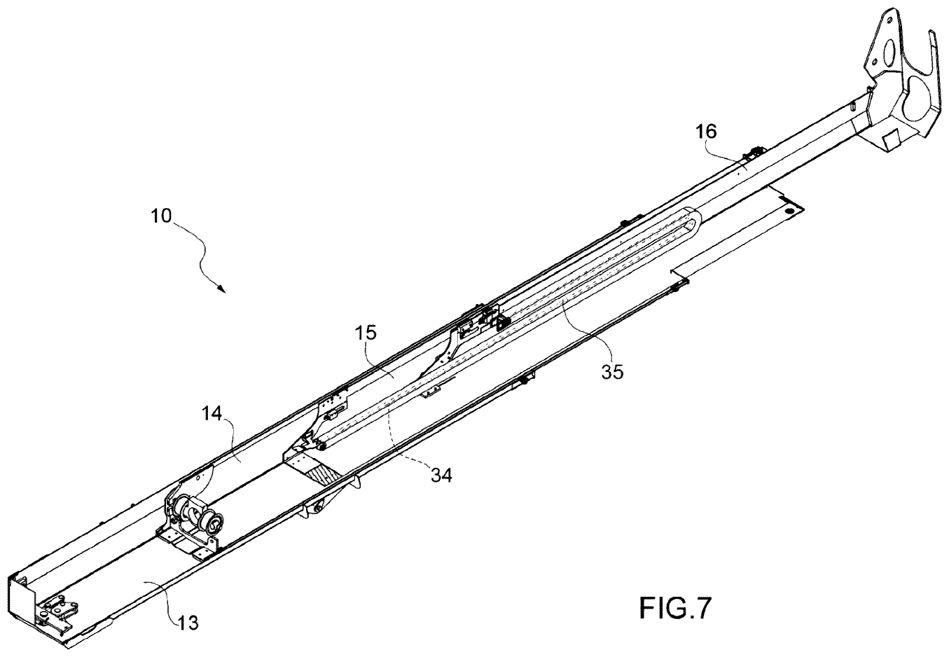

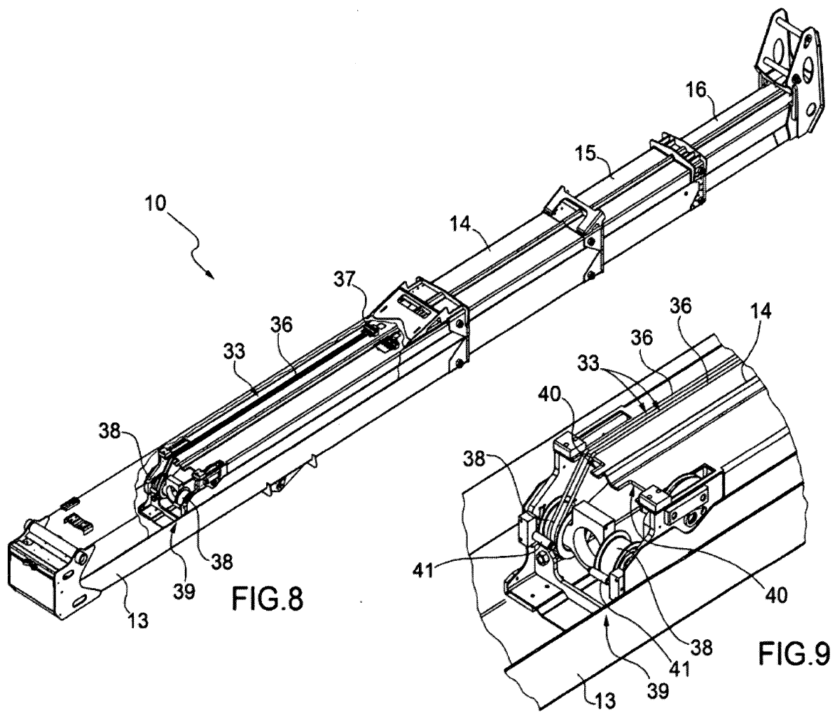

With reference to FIGS. 7, 8 and 9, the unit 9 further comprises a plurality of pipes 33 (in this case four pipes 33, only two of which are shown in FIGS. 8 and 9) fitted inside the arm 10 to feed an operating fluid, usually oil, along the arm 10 to at least one user (not shown) connected above the arm 10.

Each pipe 33 comprises a flexible segment 34 housed inside a cable-holding chain 35, which is fitted inside the arm 10 and fixed at its free ends to the section bar 15 and the section bar 16, to guide the flexible segment 34 during the movements of the section bar 16 between its extracted and retracted positions.

The flexible segment 34 is fastened to the section bars 15 and 16, configured to feed the operating fluid from the section bar 15 to the section bar 16, and connected to a further flexible or rigid segment (not shown) of the pipe 33 fixed along the section bar 16.

Each pipe 33 further comprises a flexible segment 36 (FIGS. 8 and 9), which has one first free end 37 fastened to the section bar 13, is wound around a respective pulley 38 rotatably mounted at one open free end of the section bar 14, extends inside the section bar 14, and has one second free end (not shown) fastened to the section bar 15.

The flexible segment 36 is configured to feed the operating fluid from the section bar 13 to the section bar 15, is connected to the flexible segment 34, and also connected to a further flexible or rigid segment (not shown) of the pipe 33 fixed along the section bar 13.

The flexible segment 36 is housed inside the arm 10, and extends parallel to direction 17 inside a hollow space defined between the section bar 13 and the section bar 14.

The pulleys 38 define part of a guide device 39 further comprising, in this case, two sliding guides 40 formed on the section bar 14 and slidably engaged by the flexible segments 36 of the pipes 33 and, for each pulley 38, a respective countering roller 41 mounted on the section bar 14.

Since the flexible segments 36 of the pipes 33 are guided within the hollow space defined between the section bar 13 and the section bar 14 and by the guide device 39, the aerial work platform 1 has some advantages mainly due to the fact that the flexible segments 36 of the pipes 33 do not have to be guided within a cable-holding chain similar to the cable-holding chain 35 and that, consequently, the assembly defined by the actuator cylinder 19, the rope-operated systems 20, 21, 22, 23, the pipes 33 and the cable-holding chain 35 can be entirely housed inside the arm 10.

1. An aerial work platform comprising:
a chassis;
a tractive assembly coupled to the chassis;
a stabilizer including a stabilizer arm movable between a rest position and an operating position;
a cage defining a supporting surface configured to support a person; and
a lifting assembly coupling the cage to the chassis and movable between a raised position and a fully lowered position, the lifting assembly including:
a first lift arm extending along a first axis from a first proximal end portion to a first distal end portion, wherein the first proximal end portion is coupled to the chassis; and
a second lift arm extending along a second axis from a second proximal end portion to a second distal end portion, wherein the second proximal end portion is coupled to the first distal end portion, and wherein the second distal end portion is coupled to the cage,
wherein the first distal end portion and the second distal end portion extend in opposite directions when the lifting assembly is in the fully lowered position.

2. The aerial work platform of claim 1, further comprising a turret rotatably coupled to the chassis and configured to rotate about a substantially vertical axis, wherein the first proximal end portion of the first lift arm is coupled to the chassis through the turret.

3. The aerial work platform of claim 2, wherein the tractive assembly includes a track extending longitudinally along the chassis and configured to propel the aerial work platform.

4. The aerial work platform of claim 3, wherein the substantially vertical axis is longitudinally offset from a center of the track.

5. The aerial work platform of claim 3, wherein the stabilizer arm is rotatable about a substantially horizontal axis, and wherein the substantially horizontal axis is longitudinally offset from the track when the stabilizer arm is in the rest position.

6. The aerial work platform of claim 5, wherein the substantially horizontal axis is longitudinally offset forward of the track when the stabilizer arm is in the rest position.

7. The aerial work platform of claim 6, wherein the stabilizer arm is a first stabilizer arm and the substantially horizontal axis is a first substantially horizontal axis, wherein the stabilizer includes a second stabilizer arm movable between a rest position and an operating position, wherein the second stabilizer arm is rotatable about a second substantially horizontal axis, and wherein the second substantially horizontal axis is longitudinally offset rearward of the track when the second stabilizer arm is in the rest position.

8. The aerial work platform of claim 1, wherein the stabilizer arm extends in a longitudinal direction and upward from the chassis when the stabilizer arm is in the rest position.

9. The aerial work platform of claim 8, wherein the stabilizer arm is a first stabilizer arm, wherein the stabilizer includes a second stabilizer arm movable between a rest position and an operating position, and wherein the second stabilizer arm extends in the longitudinal direction and upward from the chassis when the second stabilizer arm is in the rest position.

10. The aerial work platform of claim 9, wherein the longitudinal direction is a forward longitudinal direction, and wherein the second stabilizer arm is offset from the first stabilizer arm in the forward longitudinal direction.

11. The aerial work platform of claim 1, wherein the first lift arm includes a first section and a second section received within the first section, and wherein the second section is slidable relative to the first section to vary a distance between the first proximal end portion and the first distal end portion.

12. The aerial work platform of claim 11, wherein the first lift arm includes a third section received within the second section and a fourth section received within the third section, wherein the third section is slidable relative to the second section, and wherein the fourth section is slidable relative to the third section.

13. The aerial work platform of claim 11, wherein the second section is slidable relative to the first section along the first axis, and wherein the first axis extends downward from the first proximal end portion of the first lift arm when the lifting assembly is in the fully lowered position.

14. The aerial work platform of claim 11, wherein the second lift arm includes a third section and a fourth section, and wherein the fourth section is slidable relative to the third section to vary a distance between the second proximal end portion and the second distal end portion.

15. The aerial work platform of claim 1, wherein the lifting assembly further includes a third lift arm extending from the second proximal end portion of the second lift arm to the cage and coupling the cage to the second lift arm.

16. The aerial work platform of claim 15, wherein the third lift arm extends lower than the first lift arm and the second lift arm when the lifting assembly is in the fully lowered position.

17. The aerial work platform of claim 1, wherein the first lift arm extends below the second lift arm when the lifting assembly is in the fully lowered position, and wherein the supporting surface of the cage is offset vertically below the first lift arm when the lifting assembly is in the fully lowered position.

18. The aerial work platform of claim 1, wherein the second lift arm extends higher than the cage when the lifting assembly is in the fully lowered position.

19. A lift device comprising:
a chassis;
a tractive assembly coupled to the chassis;
an outrigger including a stabilizer arm movably coupled to the chassis;
a work platform defining a supporting surface configured to support an operator;
a turntable rotatably coupled to the chassis; and
a lifting assembly coupling the work platform to the chassis and movable between a raised position and a fully lowered position, the lifting assembly including:
a first boom having a first end portion coupled to the turntable and a second end portion opposite the first end portion; and
a second boom having a first end portion coupled to the second end portion of the first boom and a second end portion coupled to the work platform,
wherein the first boom extends in a first longitudinal direction from the turntable when the lifting assembly is in the fully lowered position, and wherein the second boom extends in the first longitudinal direction from the work platform when the lifting assembly is in the fully lowered position.

20. An aerial work platform comprising:
a chassis;
a tractive assembly coupled to the chassis, the tractive assembly including a track extending longitudinally along the chassis and configured to propel the aerial work platform;
a stabilizer including:
a first stabilizer arm rotatable about a first substantially horizontal axis and movable between a rest position and an operating position; and
a second stabilizer arm movable between a rest position and an operating position, wherein the second stabilizer arm is rotatable about a second substantially horizontal axis;
a cage defining a supporting surface configured to support a person;
a turret rotatably coupled to the chassis and configured to rotate about a substantially vertical axis that is longitudinally offset from a center of the track; and
a lifting assembly coupling the cage to the chassis and movable between a raised position and a fully lowered position, the lifting assembly including:
a first lift arm extending along a first axis from a first proximal end portion to a first distal end portion, wherein the first proximal end portion is coupled to the turret, wherein the first lift arm includes a first section and a second section received within the first section, and wherein the second section is slidable relative to the first section along the first axis to vary a distance between the first proximal end portion and the first distal end portion;
a second lift arm extending along a second axis from a second proximal end portion to a second distal end portion, wherein the second proximal end portion is coupled to the first distal end portion; and
a third lift arm extending from the second proximal end portion of the second lift arm to the cage and coupling the cage to the second lift arm,
wherein the first substantially horizontal axis is longitudinally offset forward of the track when the first stabilizer arm is in the rest position, and wherein the first stabilizer arm extends in a forward longitudinal direction and upward from the chassis when the first stabilizer arm is in the rest position;
wherein the second substantially horizontal axis is longitudinally offset rearward of the track when the second stabilizer arm is in the rest position, and wherein the second stabilizer arm extends in the forward longitudinal direction and upward from the chassis when the second stabilizer arm is in the rest position;
wherein, when the lifting assembly is in the fully lowered position:
(a) the first distal end portion of the first lift arm and the second distal end portion of the second lift arm extend in opposite directions;
(b) the first axis extends downward from the first proximal end portion of the first lift arm;
(c) the supporting surface of the cage is offset vertically below the first lift arm;
(d) the first lift arm extends below the second lift arm;
(e) the second lift arm extends higher than the cage; and
(f) the third lift arm extends lower than the first lift arm and the second lift arm.
